(19) United States
(12) Patent Application Publication
(10) Pub. No.: US 2026/0254093 A1
(43) Pub. Date: Aug. 27, 2026

(54) BASE STATION ANTENNA AND PACKAGE FOR SHIPPING SAME

(71) Applicant: OUTDOOR WIRELESS NETWORKS LLC, Claremont, NC (US)

(72) Inventors: Puliang TANG, Suzhou (CN); Samantha MERTA, Richardson, TX (US); Prabhat KUMAR, Gao (IN); Keyun DI, Suzhou (CN); Xiaofeng WANG, Suzhou (CN)

(21) Appl. No.: 18/872,555

(22) PCT Filed: Jul. 9, 2022
(86) PCT No.: PCT/CN2022/104780

§ 371 Date: Dec. 6, 2024

(51) Int. Cl. H01Q 1/12; H01Q 1/24

(52) U.S. Cl. CPC H01Q 1/1207; H01Q 1/246

(57) ABSTRACT

A packaged antenna includes: an elongate base station antenna having first and second ends and a plurality of mounting brackets extending from a lower surface thereof; a series of foamed polymer braces engaging and supporting the antenna; first and second support blocks engaging, respectively, the first and second boots; and a plurality of sleeves, each engaging a respective mounting bracket.

### TECHNICAL FIELD

The present disclosure relates to the field of packaging and transportation of base station antennas.

### BACKGROUND OF INVENTION

Base station antennas are widely used in cellular communications systems. The base station antennas are used to transmit RF signals to users and to receive RF signals from users, thereby realizing the transmission of information.

As shown in FIG. 1, a base station antenna may generally comprise a housing 1 and electronic elements (such as patch, dipole or crossed dipole radiating elements, which are not shown in FIG. 1) accommodated within the housing 1. At least one end cover 2 of the housing 1 is typically provided with a plurality of protruding elements 3 (e.g., interface elements or connector ports for connecting with various cables) that protrude outwardly from the end cover 2. During the transportation of the base station antenna, some cushioning devices may be needed to protect the electronic elements within the base station antenna and the protruding elements 3 provided on the end cover 2 as well as mounting brackets 4 attached to the rear (shown as lower) surface of the antenna 1.

Currently, in order to protect the base station antenna, foams and/or cushions made of Expandable Polyethylene (EPE) materials are typically used. Then the base station antenna along with foams and/or cushions are placed in a carton (e.g., a cardboard carton) for transportation. The adequacy of the cushioning may be assessed in different ways; for example, via a drop test.

### BRIEF DESCRIPTION OF THE FIGURES

FIG. 1 is a perspective view of an exemplary base station antenna.

FIG. 2 is a side view of a base station antenna and protective cushions to be used in packaging the antenna according to embodiments of the invention.

FIG. 3 is an end view of the antenna of FIG. 2 with a protective rubber boot mounted thereto.

FIG. 4 is an opposite end view of the antenna of FIG. 2 with a protective rubber boot mounted thereon.

FIG. 5 is an end view of the boot of FIG. 3.

FIG. 6 is a perspective view of a protective cushion employed to protect the ears of the mounting brackets of the antenna of FIG. 2.

FIG. 7 is a perspective view of a base station antenna and protective cushions to be used in packaging the antenna according to alternative embodiments of the invention.

FIG. 8 is perspective view of an enhanced end cushion as in FIG. 7.

FIG. 9 is a perspective view of an enhanced end cushion as in FIG. 7 that is mounted on the opposite end of the antenna from the end cushion of FIG. 8.

FIG. 10 is a perspective view of the antenna and protective cushions of FIG. 7 residing in a shipping carton.

FIG. 11 is a perspective view of a base station antenna, protective cushions and shipping carton according to further embodiments of the invention.

FIG. 12 is an exploded perspective view of the components of FIG. 11.

FIG. 13 is a table exhibiting specifications of an exemplary drop test for a packaged antenna as shown in FIG. 2.

FIG. 14 is a table showing typical dimensions for an antenna packaged conventionally, packaged as in FIGS. 7-10 (Carton A) and packaged as in FIGS. 11 and 12 (Carton B).

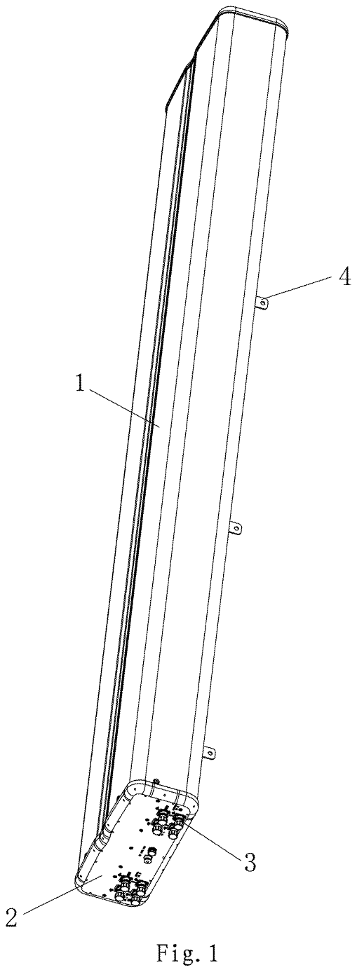

### DETAILED DESCRIPTION

The present disclosure will be described below with reference to the drawings, in which several embodiments of the present disclosure are shown. It should be understood, however, that the present disclosure may be presented in multiple different ways, and not limited to the embodiments described below. In fact, the embodiments described hereinafter are intended to make a more complete disclosure of the present disclosure and to adequately explain the protection scope of the present disclosure to a person skilled in the art. It should also be understood that, the embodiments disclosed herein can be combined in various ways to provide more additional embodiments.

It should be understood that terms in the specification are only used for describing particular embodiments and are not intended to define the present disclosure. All the terms used in the specification (including the technical terms and scientific terms) have the meanings as normally understood by a person skilled in the art, unless otherwise defined. For the sake of conciseness and/or clarity, the well-known functions or constructions may not be described in detail any longer. The singular forms “a/an”, “said” and “the” as used in the specification, unless clearly indicated, all contain the plural forms. The terms “comprising”, “encompassing” and “containing” used in the specification indicate the presence of the claimed features, but do not preclude the presence of one or more other features.

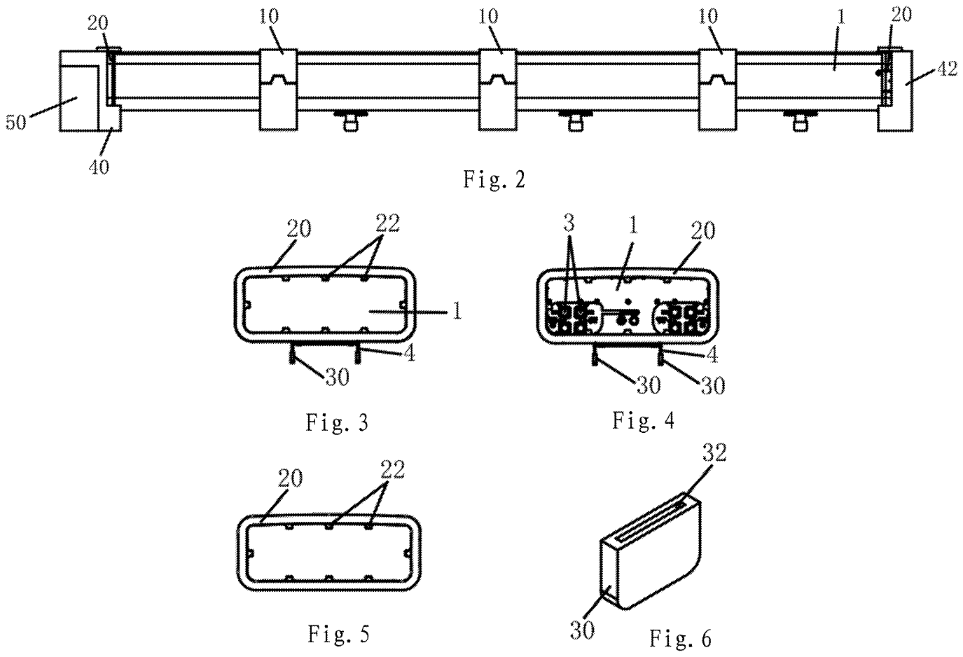

Referring now to the figures, protective cushions for the packaging of the exemplary base station antenna 1 are shown in FIGS. 2-5. The protective packaging includes three braces 10 that encircle the antenna 1 at three locations along the length of the antenna 1. The braces 10 are typically formed of EPE.

At each end of the antenna 1, a hollow, rectangular rubber boot 20 is mounted thereon. Each boot 20 includes protrusions 22 that extend into the interior of the boot 20 (see FIG. 5). As can be seen in FIGS. 3 and 4, the same boot 20 can be used on both ends of the antenna 1, and do not interfere with the ports 3 of the antenna 1. The boots 20 provide protective cushioning to the ends of the antenna 1 (typically these are separate end caps of the antenna), and in particular protect the upper surfaces of the end caps.

Referring now to FIG. 6, a flat rubber sleeve 30 with a slot 32 in its upper end is shown therein. As shown in FIGS. 2-4, the rubber sleeve 30 fits over the outwardly-extending “fingers” or “ears” of mounting brackets 4 that are mounted to the rear surface of the antenna 1.

Referring again to FIG. 2, two support blocks 40, 42 are attached to the opposite ends of the antenna 1. The support block 40 is shaped to engage the boot 20 on the upper end of the antenna 1 within a recess (see recess 141 in FIG. 9). The support block 42 is shaped to engage the boot 20 on the lower end of the antenna 1, and typically includes features for the ports 3 of the antenna 1 (see features 144 in FIG. 8) within the recess 143. The support blocks 40, 42 may be formed of any suitable material, but commonly are formed of EPE.

In addition, a mounting kit 50 is positioned to fit within the support block 40. The mounting kit 50 may contain brackets, fasteners, clamps and the like to enable the antenna 1 to be mounted to a mounting structure, such as a mounting pole.

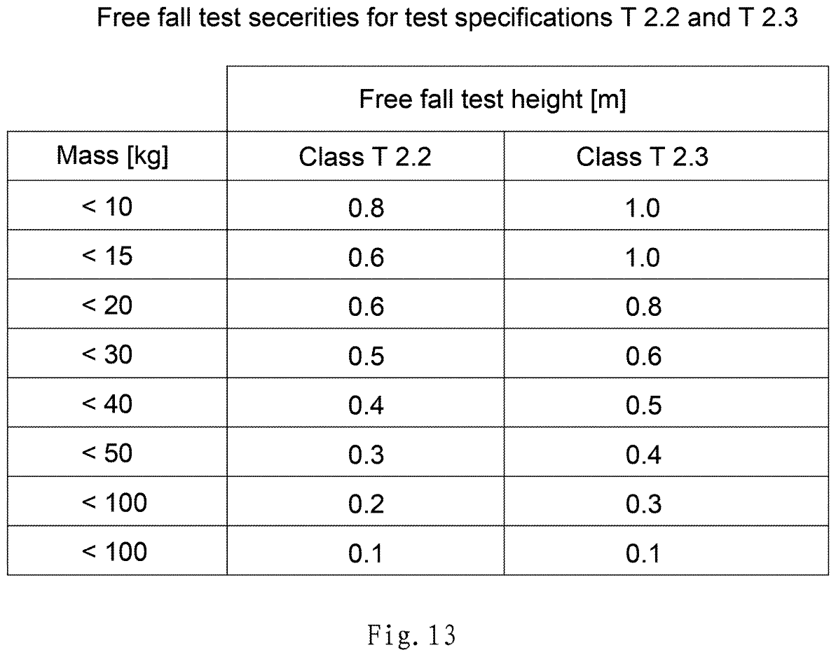

The rubber boots 20 and the rubber sleeves 30 can provide the packaged antenna 1 with protection during shipping. Specifically, the antenna 1 as packaged can pass a drop test that is conducted to determine if packaging is adequate to protect the antenna 1. FIG. 13 shows the testing parameters for a drop test for an antenna packaged as shown in FIG. 2, with different drop heights shown for different weights and types of antennas.

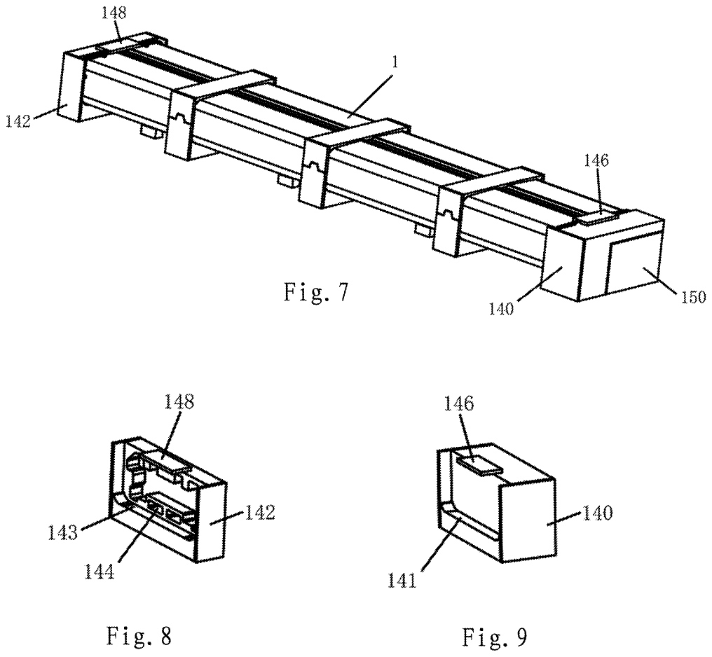

Referring now to FIGS. 7-9, another embodiment of protective packaging for a base station antenna 1 is shown therein. Like the packaging shown in FIGS. 2-6, the protective packaging includes three EPE braces 10 that encircle the antenna 1 at three locations along the length of the antenna 1. The protective packaging of FIGS. 7-9 lacks the rubber boots 20 and rubber sleeves 30 shown in FIGS. 2-6. Instead, EPE sleeves 130 with slots on their upper surfaces (not shown) are mounted onto the ears or fingers of the mounting brackets 4 of the antenna 1, and support blocks 140, 142 are each enhanced with a respective thin protective shim 146, 148. As can be seen in FIGS. 8 and 9, the protective shims 146, 148 are attached to the upper surfaces of the support blocks 140, 142 and extend therefrom in a cantilevered fashion. In this disposition, the shims 146, 148 are able to overlie the upper surface of the end cap of the antenna and provide protective cushioning.

The shims 146, 148 may be attached to the support blocks 140, 142 via any known method, but are typically attached via an adhesive. In some embodiments, the shims 146, 148 may be formed during the formation of the support blocks 140, 142 (e.g., during machining with a routing tool or the like).

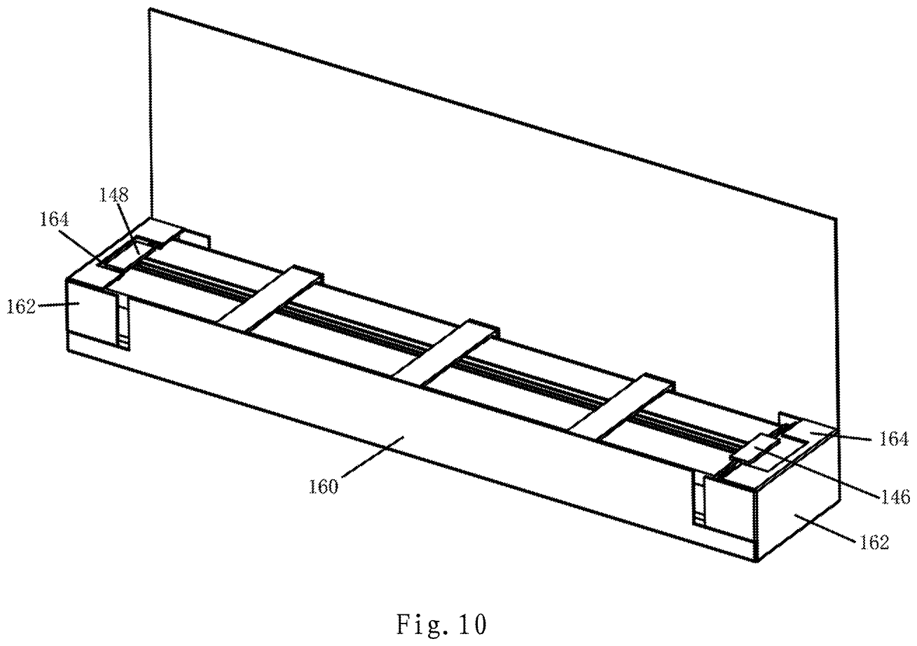

FIG. 10 illustrates the antenna 1 and the protective packaging of FIGS. 7-9 within a shipping carton 160. The shipping carton 160 is an elongate, generally rectangular box and includes end portions 162 with cutouts 164 that receive one or both of the shims 146, 148. Also, in the illustrated embodiment, the mounting kit 150 is nested within the support block 140 (this can be seen in FIG. 7).

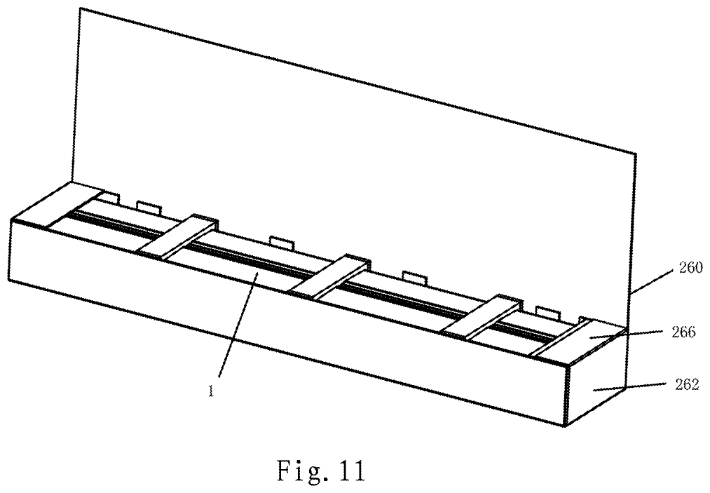

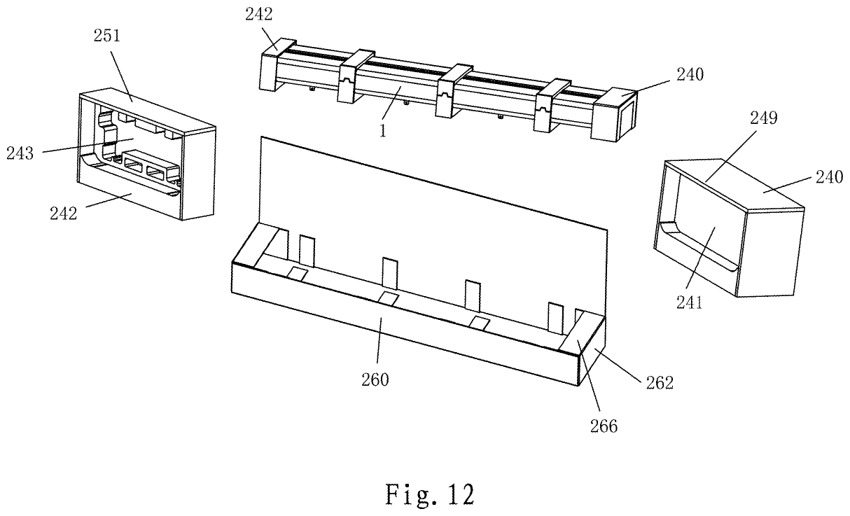

FIGS. 11 and 12 illustrate another arrangement of protective packaging. In this embodiment, each of the support blocks 240, 242 includes a ceiling 249, 251 that overlies the recesses 241, 243. A mounting kit 250 resides in a recess in the support block 240. As can be seen in FIG. 11, there is no need for a cutout area in the end portions 262 of the shipping carton 260; instead, the upper panels 266 of the end portions directly overlie the support blocks 240, 242.

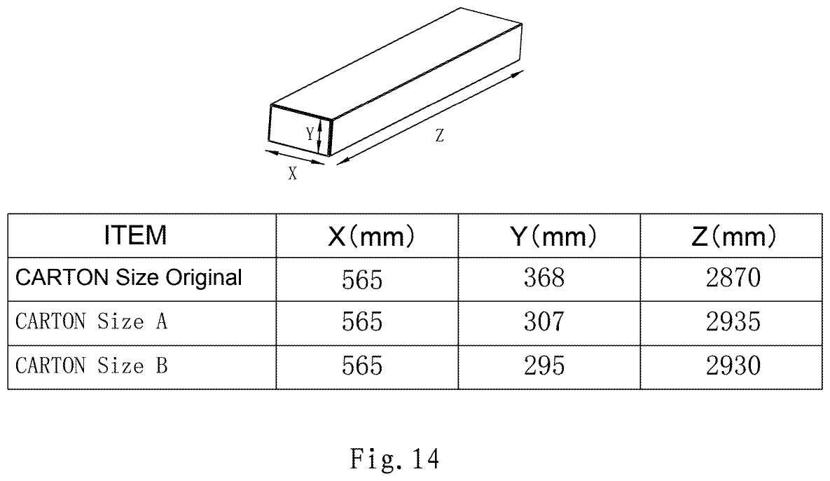

FIG. 14 is a table showing exemplary dimensions for a conventional packaged antenna as compared to an antenna packaged as in FIGS. 7-10 (labeled Carton A in FIG. 14) and an antenna packaged as in FIGS. 11 and 12 (labeled Carton B) in FIG. 14. FIG. 14 shows that both Carton A and Carton B present a considerably shorter package (in the Y-direction of FIG. 14) than the conventional package, which enables more antennas to be shipped on a single pallet. Also, the overall shipping volume may be reduced as much as 20 percent, and the volume of EPE used may be reduced as much as 5 percent.

Although the exemplary embodiments of the present disclosure have been described, a person skilled in the art should understand that, he or she can make multiple changes and modifications to the exemplary embodiments of the present disclosure without departing from the spirit and scope of the present disclosure. Accordingly, all the changes and modifications are encompassed within the protection scope as defined by the claims of the present invention.

1. A packaged antenna, comprising:
an elongate base station antenna having first and second ends and a plurality of mounting brackets extending from a lower surface thereof;
a series of foamed polymer braces engaging and supporting the antenna;
first and second rubber boots mounted on, respectively, the first and second ends of the antenna;
first and second support blocks engaging, respectively, the first and second boots; and
a plurality of sleeves, each engaging a respective mounting bracket.

2. The packaged antenna defined in claim 1, further comprising a carton enclosing the antenna, the braces, the first and second boots, the first and second blocks and the sleeves.

3. The packaged antenna defined in claim 1, further comprising a mounting kit.

4. The packaged antenna defined in claim 3, wherein the mounting kit is stored in a recess in the first support block.

5. The packaged antenna defined in claim 1, wherein the braces are formed of EPE.

6. The packaged antenna defined in claim 1, wherein the first and second support blocks are formed of EPE.

7. The packaged antenna defined in claim 1, wherein the sleeves are formed of rubber.

8. A packaged antenna, comprising:
an elongate base station antenna having first and second ends and a plurality of mounting brackets extending from a lower surface thereof;
a series of foamed polymer braces engaging and supporting the antenna;
first and second support blocks, wherein each of the first and second support blocks includes a recess, the first and second ends of the antenna engaging, respectively, the recesses of the first and second support blocks;
a plurality of sleeves, each engaging a respective mounting bracket; and
first and second shims, each mounted in cantilevered fashion to a respective support block and overlying a respective one of the first and second ends of the antenna.

9. The packaged antenna defined in claim 8, further comprising a carton enclosing the antenna, the braces, the first and second support blocks, the first and second shims, and the sleeves.

10. The packaged antenna defined in claim 8, further comprising a mounting kit.

11. The packaged antenna defined in claim 10, wherein the mounting kit is stored in a second recess in the first support block.

12. The packaged antenna defined in claim 1, wherein the braces are formed of EPE.

13. The packaged antenna defined in claim 1, wherein the first and second support blocks are formed of EPE.

14. The packaged antenna defined in claim 1, wherein the sleeves are formed of EPE.

15. A packaged antenna, comprising:
an elongate base station antenna having first and second ends and a plurality of mounting brackets extending from a lower surface thereof;
a series of foamed polymer braces engaging and supporting the antenna;
first and second support blocks, wherein each of the first and second support blocks includes a recess, the first and second ends of the antenna engaging, respectively, the recesses of the first and second support blocks, each of the support blocks having a ceiling that overlies a respective first or second end; and
a plurality of sleeves, each engaging a respective mounting bracket.
